(19) United States
(12) Patent Application Publication
(10) Pub. No.: US 2005/0128168 A1
(43) Pub. Date: Jun. 16, 2005

(54) Topology for increasing LED driver efficiency

(76) Inventor: Kevin P. D'Angelo, (US)

Correspondence Address: ADVANCED ANALOGIC TECHNOLOGIES, 830 EAST ARQUES AVE, SUNNYVALE, CA, 94085, US

(21) Appl. No.: 10/794,247

(22) Filed: Mar. 5, 2004

Related U.S. Application Data
(60) Provisional application No. 60/527,570, filed on Dec. 8, 2003.

(51) Int. Cl. G09G 3/32

(52) U.S. Cl. 345/82

(57) ABSTRACT

A method for driving a series of LEDs includes the steps of monitoring the forward voltage of at least one of the LEDs and configuring the LED to be powered by a combination of a current source and a battery if the voltage of the battery exceeds the forward voltage of the LED combined with an offset voltage required to operate the current source. In the alternative (i.e., where the voltage of the battery fails to exceed the forward voltage of the LED combined with the offset voltage required to operate the current source) the LED is configured to be powered by a combination of a current source and a boost converter. In this way, each LED in a series is powered by the most efficient choice between battery and boost converter.

### RELATED APPLICATIONS

This application claims the benefit of a U.S. Provisional Patent Application Ser. No. 60/527,570 entitled “Topology for Increasing LED Driver Efficiency” filed Dec. 8, 2003. The disclosure of that provisional application is incorporated in this document by reference.

### TECHNICAL FIELD

The present invention relates to drivers used to power light emitting diodes (LEDs) and other devices. More particularly, the present invention relates to efficient drivers for white LED applications in portable electronic systems.

### BACKGROUND OF THE INVENTION

Extending battery life is one of the most important tasks faced by designers of portable electronic systems. This is particularly true for consumer electronics, such as cellular phones, digital cameras, portable computers and other handheld equipment. Designers of these products are faced with a continual need to reduce package size (and battery size) while increasing battery life to match or exceed competitive products.

White LEDs are commonly used to illuminate color displays in portable electronic systems. The forward voltage of these LEDs is usually higher than the voltage available from common battery chemistries and configurations. As a result, some form of driver is typically used to regulate voltage and current whenever white LEDs are powered by batteries. The relatively large amount of current handled by drivers of this type makes their efficiency (typically denoted η) a critical consideration for designers of portable electronic systems.

As shown in FIG. 1, a typical LED driver includes a voltage regulator and a current controller. The voltage regulator is generally a step-up type DC/DC converter circuit, employing either an inductor-based switching converter or a capacitive charge pump. For many applications, the current controller is a current source powered by the output of the voltage regulator and is placed in series with the LED and electrical ground. With this combination, multiple LEDs can be driven in parallel. Powering multiple parallel connected LEDs from a single-output current source, however, suffers from variation in LED brightness resulting from random mismatch in LED forward voltage V_{f}.

U.S. patent application Ser. No. 10/369,982 describes an efficient driver for light emitting diodes. For that driver, LED's are driven using a combination of a current source and a boost converter (a charge pump in most implementations). The boost converter is enabled when the forward voltage (Vf) of the driven LED requires it, otherwise the charge pump remains disabled. This architecture works well and is highly efficient for single LEDs. Unfortunately, LEDs exhibit great variability in forward voltage. Vf can differ by as much as one volt even for LEDs from the same production lot. This creates an undesired inefficiency when the previously described LED driver is used to drive multiple LEDs. This results because the boost converter in that architecture becomes enabled whenever the forward voltage of any single LED requires it, even if all other LEDs do not.

For this reason, there is a need for an efficient LED driver for use with multiple LEDs. This need is particularly relevant to portable electronic systems where increased efficiency is directly related to increased battery life.

### SUMMARY OF THE INVENTION

The present invention provides a high efficiency topology for driving multiple LEDs (and related devices) with high efficiency. A representative implementation of the driver topology pairs each LED to be driven with a current source. Each current source is connected through a pair of switches to a battery and to a charge pump. This allows each LED to operate in two modes: battery mode and charge pump mode. Comparators monitor the forward voltage of each LED. Battery mode is used when an LED's forward voltage combined with the overhead of the LED's associated current source is less than the battery voltage. Charge pump mode is used when an LED's forward voltage combined with the overhead of the LED's associated current source exceeds the battery voltage. The choice between battery mode and charge pump mode is made on a LED-by-LED basis. Thus, each LED only enters charge pump mode when required by its own forward voltage (and the voltage overhead of its associated current source). The charge pump is only activated when one or more LEDs are operating in charge pump mode and is disabled otherwise. By selecting between charge pump and battery mode individually for each LED, efficiency is increased.

### BRIEF DESCRIPTION OF THE DRAWINGS

FIG. 1 is a block diagram of a prior art LED driver using a current source in series with a voltage regulator.

FIG. 2 is a block diagram of an LED driver topology as provided by an embodiment of the present invention.

FIG. 3 is a diagram that shows the operation of a series of LEDs driven using a topology of the present invention as a function of battery voltage.

FIG. 4 is a diagram that shows how the efficiency of the topology of FIG. 2 changes as a function of battery voltage.

### DETAILED DESCRIPTION OF THE PREFERRED EMBODIMENTS

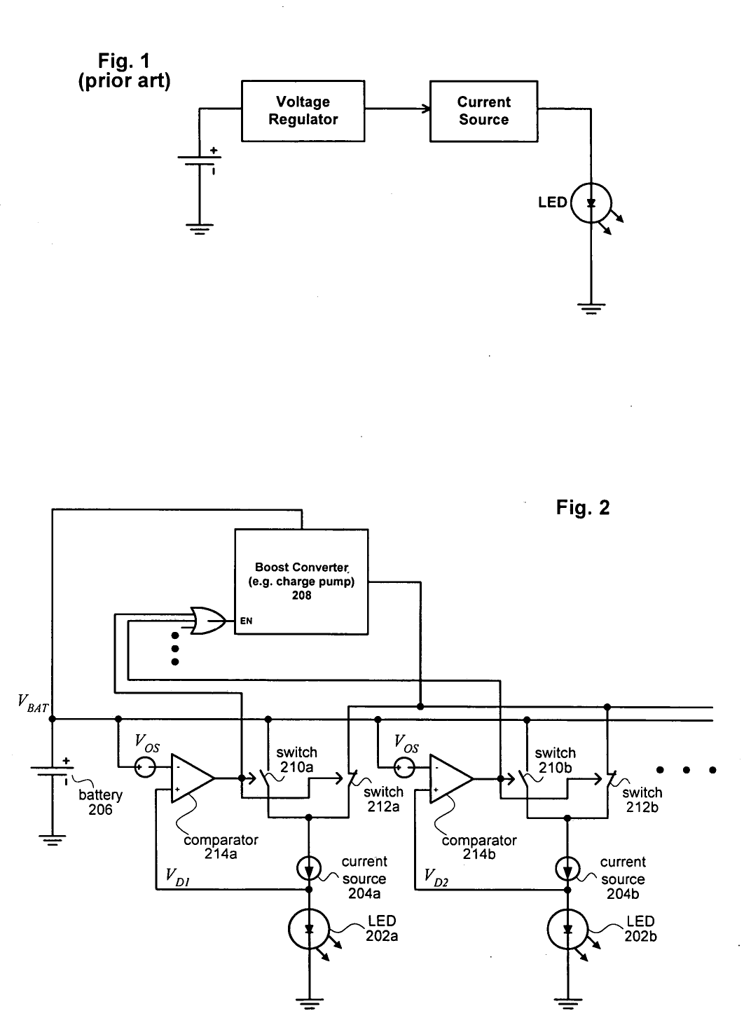

The present invention provides a high efficiency topology for driving multiple LEDs (and related devices) with high efficiency. As shown in FIG. 2, a representative implementation of the topology 200 includes a series of LEDs, represented by LED 202a and 202b. In general, although two LEDs 202 are shown, it should be appreciated topology 200 is intended to be support any useful number. Each LED is connected to a current source 204 which are driven, in turn by either a battery (not shown) or a charge pump 208. The choice between battery and charge pump 208 is controlled by two switches per current source. These are designated 210 (closed when current sources 204 are driven by the battery) and 212 (closed when current sources 204 are driven by charge pump 208).

Switches 210 are controlled by the outputs of respective comparators 214. In this way, the output of each comparator 214 determines if its associated LED is driven by the battery or by charge pump 208. The inputs to comparators 214 are the LED forward voltage (V_{f}) (of the associated LED) and the difference between the battery voltage V_{BAT} and an offset voltage Vₒₛ, where Vₒₛ is the overhead required by each current source 204. The battery is selected for a given LED 202 as long as V_{f} (for that LED 202) stays below V_{BAT} minus Vₒₛ. Otherwise, charge pump 208 is selected. In other words, the battery is used as long as the battery voltage is sufficient to run the combination of an LED 202 and its associated current source 204. Otherwise, that LED 202 is switched to be supplied by charge pump 208. The choice between battery and charge pump 208 is made on a case-by-case basis. Thus, there will typically be cases where some LEDs 202 are battery drive while others are power by charge pump 208.

The operation of charge pump 208 is controlled by an or gate 216. Or gate 216 is driven by the output of comparators 214. As a result, charge pump 208 is enabled whenever required to run one of LEDs 202. Otherwise, charge pump 208 is inactive. Since in the case of a charge pump, the input current is 1.5× or 2× (depending on charge pump topology) times the diode current, any LEDs 202 not powered by charge pump 208 give a significant current savings.

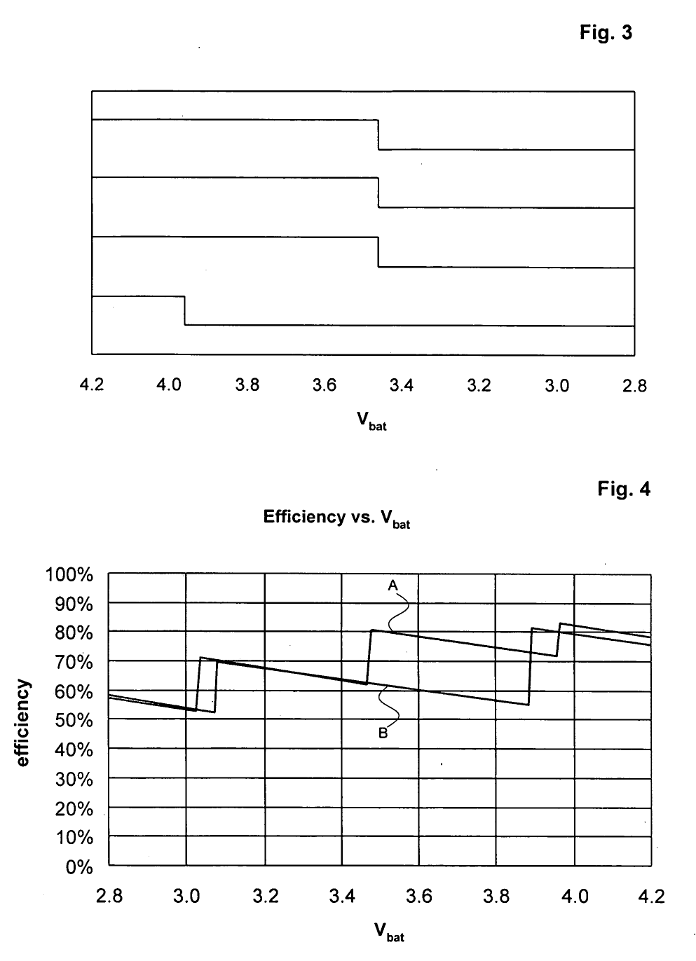

An example of this is shown in FIG. 3. For this particular example, it is assumed that topology 200 is configured to drive four LEDs 202. One of these has a forward voltage of 3.7V. The remaining three have forward voltages of 3.2V. Battery voltage is assumed to start at 4.2V and Vₒₛ is assumed to be approximately 0.26V (this example ignores the fact that Vₒₛ will typically vary between current sources 204). At the initial battery voltage of 4.2V all LEDs 202 operate using the battery. As the battery voltage falls below ˜3.96V (i.e., V_{f} plus Vₒₛ for the first LED 202), the first LED 202 is switched to be powered by charge pump 208. The remaining three LEDs 202 are powered by the battery until battery voltage falls below ˜3.46V (i.e., V_{f} plus Vₒₛ for the remaining LEDs 202). At that point, the remaining LEDs 202 are switched to be powered by charge pump 208.

FIG. 4 shows how the efficiency of topology 200 changes as a function of battery voltage. Two traces are shown. The first (labeled “A”) shows efficiency for the LEDs 202 just described (i.e., V_{f}¹=3.7V, V_{f}²=V_{f}³=V_{f}⁴=3.2V). The second trace (labeled “B”) shows efficiency compared to battery voltage for a second series of LEDs. The LEDs in that series all have a forward voltage of 3.5V. By inspection, it is clear the architecture of the current invention is able to run the first series of LEDs (with their mixed forward voltages) with greater efficiency (e.g., efficiency is improved 18% at V_{BAT}=3.6 v).

In general, it should be noted that the topology described above is adaptable for a number of different implementations. This specifically includes an implementation where charge pump 208 is replaced by the combination of a charge pump and a DC/DC converter. A second implementation uses a voltage regulator in place of charge pump 208. The details of these configurations along with several variations are described in U.S. patent application Ser. No. 10/369,982. It should also be noted that while driving white LEDs is a prime application of the described topology, applications exist for colored LEDs as well. This occurs, for example when white LEDs are used to illuminate a display in combination with colored LEDs that illuminate a translucent keyboard (a description that matches) many current cellular telephone designs. In such cases, the white and colored LEDs typically have different forward voltages and benefit from the driver topology described above. Another example occurs when driving RGB (red, green, blue) LED arrays. Once again, the different LED colors tend to have different forward voltages and may benefit from the described driver topology.

Although particular embodiments of the present invention have been shown and described, it will be apparent to those skilled in the art that changes and modifications may be made without departing from the present invention in its broader aspects, and therefore, the appended claims are to encompass within their scope all such changes and modifications that fall within the true scope of the present invention.

1. A circuit for driving a series of two or more LEDs, the circuit comprising:
a boost converter;
a current source connected to provide a forward current to one of the LEDs; and
a control circuit associated with the current source, the control circuit configured to supply the current source with the output of a battery when the voltage of the battery exceeds a predetermined level and to supply the current source with the output of the boost converter when the voltage of the battery fails to exceed the predetermined level.

2. A circuit as recited in claim 1 in which the predetermined level is equal to the forward voltage of the LED combined with an offset voltage required to operate the current source.

3. A circuit as recited in claim 1 in which control circuit is configured to enable the charge pump when the voltage of the voltage of the battery fails to exceed the predetermined level.

4. A circuit for driving a series of two or more LEDs, the circuit comprising:
a boost converter;
a respective current source for each LED; and
a control circuit configured to cause at least one LED to operate in either a first mode where the LED is powered by the output of a battery, or a second mode where the LED is powered by the output of a boost converter, the control circuit selecting first or second mode operation based on the voltage needed to drive the LED and the voltage available from the battery.

5. A circuit as recited in claim 4 in which the control circuit selects first mode operation for any LED when the forward voltage of that LED combined with an offset voltage required to operate the respective current source is less than the voltage available from the battery.

6. A circuit as recited in claim 4 in which control circuit is configured to enable the charge pump when the voltage of the voltage of the battery fails to exceed the predetermined level.

7. A method for driving a series of two or more LEDs, the method comprising:
monitoring the forward voltage of at least one LED;
configuring the LED to be powered by a combination of a current source and a battery if the voltage of the battery exceeds the forward voltage of the LED combined with an offset voltage required to operate the current source; and
configuring the LED to be powered by a combination of a current source and a boost converter if the voltage of the battery fails to exceed the forward voltage of the LED combined with the offset voltage required to operate the current source.

8. A method as recited in claim 7 that further comprises the step of enabling the boost converter if the voltage of the battery fails to exceed the forward voltage of the LED combined with the offset voltage required to operate the current source.
